(19) United States
(12) Patent Application Publication
(10) Pub. No.: US 2005/0238210 A1
(43) Pub. Date: Oct. 27, 2005

(54) 2D/3D facial biometric mobile identification

(76) Inventor: Michael L. Sim, Reston, VA (US)

Correspondence Address: SCHIFF HARDIN, LLP;PATENT DEPARTMENT, 6600 SEARS TOWER, CHICAGO, IL, 60606-6473, US

(21) Appl. No.: 11/100,166

(22) Filed: Apr. 6, 2005

Related U.S. Application Data
(60) Provisional application No. 60/559,933, filed on Apr. 6, 2004.

(51) Int. Cl. G06K 9/00

(52) U.S. Cl. 382/118

(57) ABSTRACT

In a method and apparatus, an identity of a person is verified by a handheld device. The handheld device has imaging capabilities and images a person to be identified. The image information is processed in the handheld device, including generating a two dimensional facial template. The template is compared to templates in a database and the results provide a link to a photographic database. The resulting image is displayed on the handheld device.

### CROSS-REFERENCE TO RELATED APPLICATION

This application claims the benefit of U.S. Provisional Patent Application Ser. No. 60/559,933, filed Apr. 6, 2004, which is incorporated herein by reference.

### BACKGROUND OF THE INVENTION

1. Field of the Invention

The present invention relates generally to an identification method and system and in particular to a method and apparatus for authenticating an identification.

2. Description of the Related Art

Biometrics is the science of automatically identifying individuals based on their unique physiological and behavioral characteristics. Biometric information may be based on unique characteristics of a person's face, iris, voice, fingerprint, signature or DNA. These can all be used to authenticate a person's identity from information stored in a database of held on a token in two dimensional barcode, magnetic stripe, smart card, USB (Universal Serial Bus) device, memory stick or RFID (Radio Frequency Identification) format device.

The use of facial recognition has advantages over and above those of other biometrics, particularly in that the process is non-intrusive. Until recently this process was limited to the person being in front of a camera. The advent of handheld wireless technology now allows us to migrate the recognition process to remote or difficult environments.

Identification systems are disclosed in International Patent Application publications WO 00/62474 published Oct. 19, 2000, and WO 02/09024 A1 published on Jan. 31, 2002. In WO 00/62474, a computer uses a facial biometric template to encode a document. In WO 02/09024 A1, a facial identification matrix is obtained. 2D and 3D biometric templates are created from a single camera and the facial index data is extracted. These published applications are incorporated herein by reference.

### SUMMARY OF THE INVENTION

The present invention provides a method and apparatus for identification authentication including a portable device for obtaining biometric information and for processing the information to permit the information to be used in a search of a database of biometric information. The results of the search are then displayed on the portable device to permit an identification of a person to be made.

### BRIEF DESCRIPTION OF THE DRAWINGS

FIG. 1 is a schematic front view of a portable identification device having a fingerprint sensor;

FIG. 2 is a schematic review view of the portable identification device of FIG. 1 having dual imaging devices;

FIG. 3 is a top plan view of the portable identification device according to the preferred embodiment of the invention along with a process flow chart showing the steps of the present invention.

### DETAILED DESCRIPTION OF THE PREFERRED EMBODIMENTS

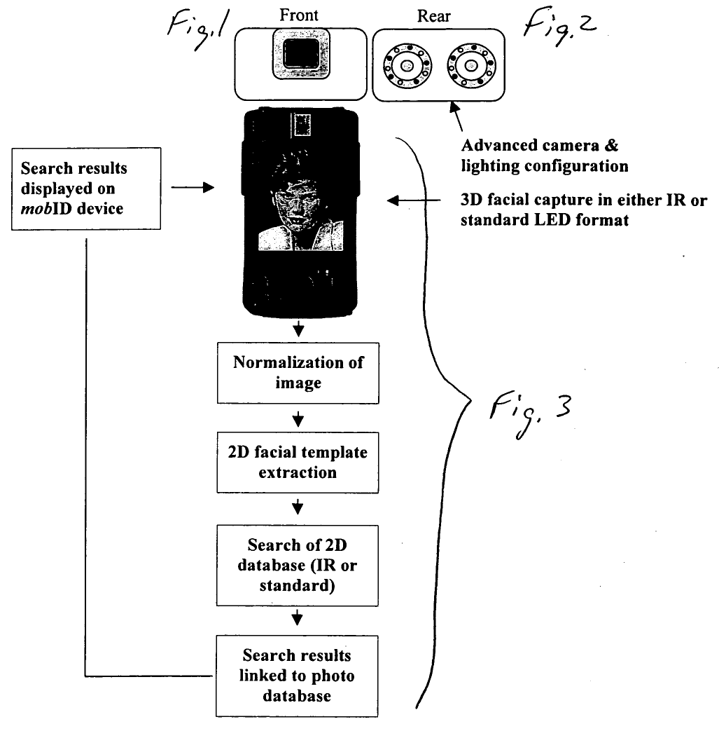

In FIG. 1 is shown schematically an identification module 10 having a rugged housing and a touch pad fingerprint sensor 12. The fingerprint sensor 12 is used to obtain fingerprint biometric data.

In FIG. 2, the other end of the identification module 10 is shown. The module has two camera lenses 14 and imaging devices facing the same direction and spaced apart by a predetermined distance. The imaging devices are electronic imaging devices, such as CCD or CMOS imaging devices. Other types of imaging chips may be provided as well. Both imaging devices are operated at the same time to take two images spaced by the predetermined distance. Thus, the imaging devices obtain a stereographic image that includes three dimensional information of the object being imaged.

Proper illumination is important during imaging using the electronic imaging system. The illumination is provided here by a ring shaped lighting system 16 surrounding each lens. The ring shaped lighting system 16 of a preferred embodiment has a plurality of LEDs in each ring. The LEDs are of two types. First, five visible light LEDs 18 are provided in the ring light system and, second, five IR (InfraRed) LEDs 20 are provided in each ring light system. Thus, each ring light system includes ten LEDs to provide illumination to the subject being imaged. To ensure that the infrared energy from the IR LEDs is effective in illuminating the subject, the imaging chip (either CCD or CMOS) does not have an IR filter. Such IR filters are common in commercial imaging systems, such as digital cameras and will not be provided here. The lighting system can use either the visible light, the infrared light or both in obtaining the stereographic images.

The stereographic images are input to software to generate two dimensional and three dimensional biometric information about a subject. The biometric information is combined. This information is stored on a data carrier that is provided to a person that has been identified. The data carrier is any of a variety of data carriers, which are referred to as a token, card, or the like.

Images of the person are obtained using a wirelessly-enabled ruggedly built handheld computer equipped with twin image capture devices. These capture devices have the following capabilities: a) Single 2D image capture in IR or standard image format, b) 3D image capture in IR or standard image format, c) Two dimensional barcode reading, d) Embedded fingerprint scanner, e) IR light source, f) Standard LED illumination

Control of either the 2D or 3D image will be achieved utilizing software switches incorporated into the main application running on the handheld computer.

In FIG. 3, the handheld device has obtained an image of a subject and processing of that image is carried out. The processing includes normalization of the image, followed by extraction of a two dimensional facial template. A search if performed of the two dimensional database, in either visible light images or infrared images. The search results are linked to a database of photographs and the resulting photograph is displayed on the handheld device for verification of the identity of the person.

A benefit of the present device is that a process is performed that utilizes several important factors, including:
1. Most legacy databases are in 2D flat format and will remain in use for many years to come.
2. 2D identification results to date have only achieved average results in the 40%-70% region of successful match.
3. The 3D capture process and conversion to enhanced 2D templates increases the identification process by up to 40% taking the results to an average of 98% level of confidence.
4. The introduction of 3D mobile device with IR capabilities takes the technology away from the constraints of a desktop to the real world environment.
5. The IR process will facilitate discrete surveillance capability in sunlight or semi darkness with either database stored in memory or wireless connectivity to a local database or WLAN/GPRS/CDMA connectivity to a central database.
6. The overall process will bridge the transition to fully integrated 3D systems while utilizing the legacy 2D facial databases.
7. The system supports the integration of all major 2D and 3D vendor facial recognition algorithms into a handheld biometric computer.
8. The use of 3D facial capture to 3D facial identification or authentications improves the reliability to a >98% level of confidence.
1. There is disclosed a method by which 3D facial image capture in IR and standard lighting format is used to search multiple legacy 2D facial recognition template records to achieve positive facial identification.
2. This process can be performed via a wirelessly enabled 3D handheld computer linked to a local server or via WLAN, CDMA or GPRS to a central server.
3. The 3D facial image can be either front-on or acquired with up to 30% rotation to the left, right, up or down. The 3D algorithm normalizes the image to a front-on facial view. At that time 2D facial software converts the 3D acquired image into an enhanced 2D facial template. This enhanced 2D template is then used to search the legacy facial records.
4. 2D templates enrolled in this way achieve an increase in identification by up to 40% from that achieved by standard or conventional 2D facial recognition algorithms utilizing with standard camera configurations (see FIG. 1).
5. Images (jpeg, bitmaps, tiffs) stored as part of the facial biometric repository are converted to negative format images. These are then processed with the 2D facial algorithm to produce a database of facial templates compatible with IR acquired input.
6. The handheld computer is then used in 3D IR format to acquire images in difficult environments including sunlight or semi darkness. These 3D IR images, if captured at an angle, are normalized to a front-on facial image. The 2D algorithm extracts an enhanced 2D IR template for comparison to the compatible format in the new database. The resultant match is linked to the standard photo database to allow visualization on the handheld computer of the stored images which will be used for visual confirmation alongside the automated identification.

Facial biometrics includes more than just surface features of the face. It includes iris, wrinkling, scarring, wounds, tattoo (and tattoo removal) patterns and features including sub-dermatological patterns, pores and other dermatological depth and variation, hair features such as thickness, baldness patterns as well as hair chemical composition, ears, teeth cavity and tooth growth patterns/dentures/gums and other features internal to the face including the mouth, nose and eyes, ears external and internal to the body, coloring, cranial and bone structure and pattern, internal anatomy, brain features, brain activity, pheromone (i.e., various odors of the person or object), salinity and chemical patterns, body temperature, motion patterns such as a specific tick or Parkinson's type shake, walking limp, nervous habit (such as scratching, tapping, knee-shaking), aura-type variations, and other features and characteristics. All of these features and characteristics can be detected and captured non-invasively as well. These are all included within the scope of the invention.

With the foregoing in mind, the identification and authentication method and system includes linked databases that might separately contain information on any one, or more than one, such feature named above. For example, the mobile device can include identification and authentication of bar coded or other stored information in more than one database. These multiple databases might include iris identification in one database and other facial identification in a second, third or more databases.

Various databases are in existence today and more are coming on-line that will have pieces of this type of biometric information—hospital records might have a cranial and brain scan MRI, dental records might have a full jaw, iris may be captured by an “agency” information database, states have pictures on licensing databases, etc. The present invention is capable of linking to and utilizing more than one database in the detection and authentication method and system.

The present system and method is designed not only to operate in normal (e.g., daylight, laboratory, good weather condition at sea level, at one atmosphere, etc) conditions. The system is mobile so that it will be utilized in a wide range of environments. These include space programs, subterranean, underwater, sea water/fresh water/brine water, excessive heat and cold, and under compromised or chemical/radiological environments including bio hazardous environments that present imperfect conditions. As such, the ruggedly built housing and the components are selected and constructed to withstand these harsh environmental conditions and so permit operation of the device wherever needed.

Not only is the system and method designed to be able to identify and authenticate in these environments as noted above, but also the method or system is designed so that it can function completely within its own ruggedized housing or enclosure. For example, a normal PDA or blackberry or the like will not function as intended in extreme environments noted above. The present device, by contrast, includes a system or method that can operate under the harsh/abnormal environment including wet (sea/fresh/brine water), hot/cold temperature conditions; chemically or radiologically- or biologically-tainted or compromised environment; excessive dust/dirt (including desert-type), wind, pressure and vibration environments.

The present application is related to the subject matter of co-pending U.S. Provisional Patent Application Ser. No. 60/559,883 filed Apr. 6, 2004, Ser. No. 60/559,804 filed Apr. 6, 2004, and Ser. No. 60/559,805 filed Apr. 6, 2004, and to the non-provisional applications claiming the benefit thereof. All of these applications are incorporated herein by reference.

Although other modifications and changes may be suggested by those skilled in the art, it is the intention of the inventors to embody within the patent warranted hereon all changes and modifications as reasonably and properly come within the scope of their contribution to the art.

1. An apparatus for authenticating an identification, comprising:
a handheld device including an imaging system in the handheld device, said imaging system being operable to generate an image of a person to be identified;
an image processing system in communication with said imaging system and operable to generate a facial template of the person to be identified from the image;
a database of facial template information of identified persons to which the facial template of the person to be identified can be compared, said facial template information in said database including links to image information of the identified persons; and
a display in said handheld device, said display being in communication with said image information to display an image of an identified person.

2. An apparatus as claimed in claim 1, wherein said communication between said imaging system and said database is a wireless communication system.

3. A method for authenticating an identity of a person to be identified, comprising the steps of:
obtaining an image of the person to be identified;
processing the image to generate a facial template of the person to be identified;
comparing the facial template of the person to be identified to facial template information of identified persons;
upon obtaining a match between the facial template of the person to be identified and facial template information of identified persons, linking to an image of the identified person corresponding to the match; and
displaying the image of the identified person corresponding to the match.

4. A method as claimed in claim 3, wherein said steps of obtaining the image of the person to be identified and displaying the image of the identified person is performed on a handheld device.
